(19) United States
(12) Patent Application Publication
(10) Pub. No.: US 2018/0199100 A1
(43) Pub. Date: Jul. 12, 2018

(54) INFORMATION PROCESSING APPARATUS AND INFORMATION PROCESSING SYSTEM

(71) Applicant: FUJI XEROX CO., LTD., Tokyo (JP)

(72) Inventors: Akira FUJII, Kanagawa (JP); Suresh MURALI, Kanagawa (JP)

(73) Assignee: FUJI XEROX CO., LTD., Tokyo (JP)

(21) Appl. No.: 15/714,164

(22) Filed: Sep. 25, 2017

(30) Foreign Application Priority Data
Jan. 6, 2017 (JP) 2017-000938

(51) Int. Cl. H04N 21/44; H04N 19/146; H04N 21/258

(52) U.S. Cl. CPC H04N 21/44004; H04N 21/25825; H04N 19/146; H04N 21/44008

(57) ABSTRACT

An information processing apparatus include: a degradation level acquirer that, when an original video is converted to A (A is a natural number) videos with different bit rates, acquires a level of degradation in each of a plurality of sections of each of the videos; a data volume calculator that calculates a data volume of distribution video data which is generated when a video with the level of degradation satisfying a first image quality condition is selected from B (B is a natural number smaller than A+1) videos for each of the plurality of sections; and an identifier that identifies a combination out of combinations of bit rates of the B videos for which the data volume is calculated, the combination allowing the data volume to be within a predetermined order from a smallest volume.

### Cross-Reference to Related Applications

This application is based on and claims priority under 35 USC 119 from Japanese Patent Application No. 2017-000938 filed Jan. 6, 2017.

### BACKGROUND

### Technical Field

The present invention relates to an information processing apparatus and an information processing system.

### SUMMARY

According to an aspect of the invention, there is provided an information processing apparatus including: a degradation level acquirer that, when an original video is converted to A (A is a natural number) videos with different bit rates, acquires a level of degradation in each of a plurality of sections of each of the videos; a data volume calculator that calculates a data volume of distribution video data which is generated when a video with the level of degradation satisfying a first image quality condition is selected from B (B is a natural number smaller than A+1) videos for each of the plurality of sections; and an identifier that identifies a combination out of combinations of bit rates of the B videos for which the data volume is calculated, the combination allowing the data volume to be within a predetermined order from a smallest volume.

### BRIEF DESCRIPTION OF THE DRAWINGS

Exemplary embodiments of the present invention will be described in detail based on the following figures, wherein:

FIG. 1 is a diagram illustrating the entire configuration of a video browsing system according to an exemplary embodiment;

FIG. 2 is a diagram illustrating the hardware configuration of a smartphone;

FIG. 3 is a diagram illustrating the hardware configuration of a video distribution apparatus, a video conversion apparatus, and a bit rate identification apparatus;

FIG. 4 is a diagram illustrating the functional configuration achieved by the video browsing system;

FIG. 5 is a diagram illustrating the mechanism of streaming-distribution;

FIG. 6 is a table illustrating an example of stored image quality information;

FIG. 7 is a table illustrating an example of determined bit rates;

FIG. 8 is a table illustrating an example of calculated data volume;

FIG. 9 is a diagram illustrating an example of steps of operation of each of apparatuses in distribution preparation processing;

FIG. 10 is a table illustrating an example of data volume calculated in a modification; and

FIGS. 11A and 11B are respectively a table and a graph illustrating an example of level of degradation evaluated by an approximate expression.

### DETAILED DESCRIPTION

[1] Exemplary Embodiment

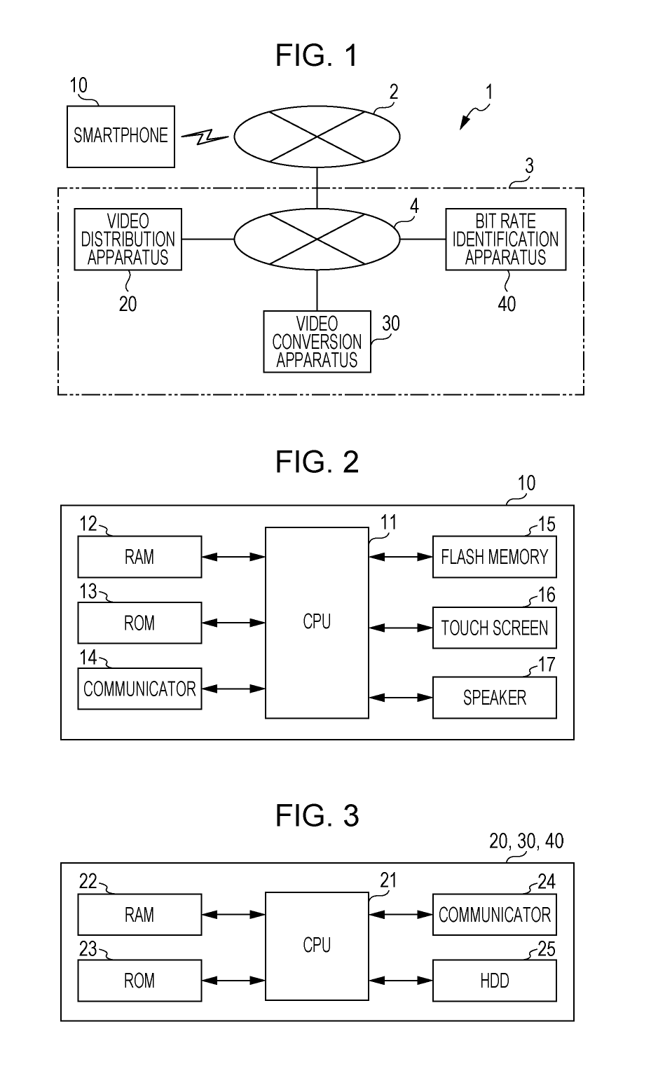

FIG. 1 illustrates the entire configuration of a video browsing system 1 according to an exemplary embodiment. The video browsing system 1 is a system that streams videos to a reproduction device utilized by a user to allow the user to browse the videos. Stream distribution of a video is to distribute the video by a mechanism in which a video is divided into multiple sections, and segment data indicating video in each section is reproduced sequentially while being transmitted and received in a reproduction order. The videos distributed include videos uploaded by users in addition to the videos prepared by business operators.

The video browsing system 1 includes a first communication line 2, a smartphone 10, and a video distribution system 3. The video distribution system 3 processes an original video such as a video provided by a business operator or a video uploaded by a user into a streamable video, and performs streaming-distribution using the video after processed. The video distribution system 3 includes a second communication line 4, a video distribution apparatus 20, a video conversion apparatus 30, and a bit rate identification apparatus 40.

The first communication line 2 is a system that serves as an intermediary of exchange of data between apparatuses, and is, for instance, a mobile communication network and the Internet. The smartphone 10 is connected wirelessly (or may be connected by wire) to the first communication line 2. In addition, the second communication line 4 is connected to the first communication line 2.

The second communication line 4 is a system that serves as an intermediary of exchange of data between apparatuses, and is, for instance, a local area network (LAN) in a data center. The video distribution apparatus 20, the video conversion apparatus 30, and the bit rate identification apparatus 40 are connected by wire (or may be connected wirelessly) to the second communication line 4.

The smartphone 10 is a reproduction device that reproduces a video that is streamed by the video browsing system 1. In addition, the smartphone 10 receives an operation of uploading a video by a user, and transmits the video to the video distribution system 3. The transmitted video is the original video to be streamed.

The video distribution apparatus 20 is an information processing apparatus that streams a video to a reproduction device such as the smartphone 10. The video distribution apparatus 20 stores multiple videos with different bit rates, which are converted from the above-mentioned original video (such as a video provided by a business operator or a video uploaded by a user). The bit rate is a data volume (for which Mbps (megabits per second) or MB/sec (megabytes per second) is used as a unit).

Specifically, the video distribution apparatus 20 stores a segment data group indicating the multiple videos as video data for distribution (video data used for streaming-distribution). The video distribution apparatus 20 performs streaming-distribution of a video by sequentially transmitting the segment data in a reproduction order. In this exemplary embodiment, the smartphone 10 determines an optimal bit rate for each section, and requests the bit rate to the video distribution apparatus 20. The video distribution apparatus 20 then reads segment data of a video with the requested bit rate from the video data for distribution, and transmits the segment data.

The video conversion apparatus 30 is an information processing apparatus that performs conversion processing for converting an original video to a video with a different bit rate. The video conversion apparatus 30 generates a video with a converted bit rate by the conversion processing, and supplies the generated video to the bit rate identification apparatus 40. Hereinafter a video generated by converting the bit rate from an original video in this manner is referred to as a “conversion video”. The bit rate identification apparatus 40 is an information processing apparatus that determines from multiple bit rates a combination of the bit rates of videos stored by the video distribution apparatus 20. The bit rate identification apparatus 40 makes the determination using the video supplied from the video conversion apparatus 30.

The more types of bit rate of videos are indicated by the video data for distribution, a more suitable bit rate is likely to be found. However, the data volume of the video data for distribution is increased, and the storage capacity of the video distribution apparatus 20 is occupied. In addition, the number of conversion processing performed by the video conversion apparatus 30 is increased, and a period from acquisition of an original video to the start of distribution is increased. Therefore, the number of types of bit rate of videos indicated by the video data for distribution may not be increased without limit, and an upper limit of the number is normally defined.

In a range not exceeding the upper limit, the bit rate identification apparatus 40 determines a combination of bit rates that achieve a relatively higher reproduction quality (high image quality and continuity (reproduction is not cut off) of reproduction of a video) of streaming-distribution. The bit rate identification apparatus 40 is an example of the “information processing apparatus” of the present invention. It is to be noted that although the video data for distribution may include the original video, in this exemplary embodiment, only the conversion video is used as the video data for distribution which does not include the original video.

The video conversion apparatus 30 converts the original video to videos with the bit rates in the determined combination to generate video data for distribution, and supplies the generated video data for distribution to the video distribution apparatus 20. The video distribution apparatus 20 stores the supplied video data for distribution, and performs streaming-distribution using the videos with the multiple bit rates indicated by the stored video data for distribution.

FIG. 2 is a diagram illustrating the hardware configuration of the smartphone 10. The smartphone 10 is a computer that includes a central processing unit (CPU) 11, a random access memory (RAM) 12, a read only memory (ROM) 13, a communicator 14, a flash memory 15, a touch screen 16, and a speaker 17. The CPU 11 uses the RAM 12 as a work area to control the operation of each component by executing a program stored in the ROM 13 or the flash memory 15. The communicator 14 has an antenna and a communication circuit, and performs communication via the first communication line 2.

The flash memory 15 stores the data and programs used by the CPU 11 for control. In this exemplary embodiment, the programs include a program of the browser, and the later-described functions of the present invention are achieved by Javascript executed on the browser. It is to be noted that without being limited to this, an application program which achieves the functions of the present invention may be stored. The touch screen 16 includes a display and a touch panel provided on the surface of the display, and displays an image as well as receives an operation from a user. The speaker 17 converts sound data indicating sound into analog signals to emit sound.

FIG. 3 illustrates the hardware configuration of the video distribution apparatus 20, the video conversion apparatus 30, and the bit rate identification apparatus 40. These apparatus are each a computer that includes the CPU 21, the RAM 22, the ROM 23, the communicator 24, and a hard disk drive (HDD) 25. The CPU 21 to the ROM 23 are in common with the hardware with the same name illustrated in FIG. 2. The communicator 24 has a communication circuit and performs communication via the second communication line 4. The HDD 25 stores the data and programs used by the CPU 21 for control.

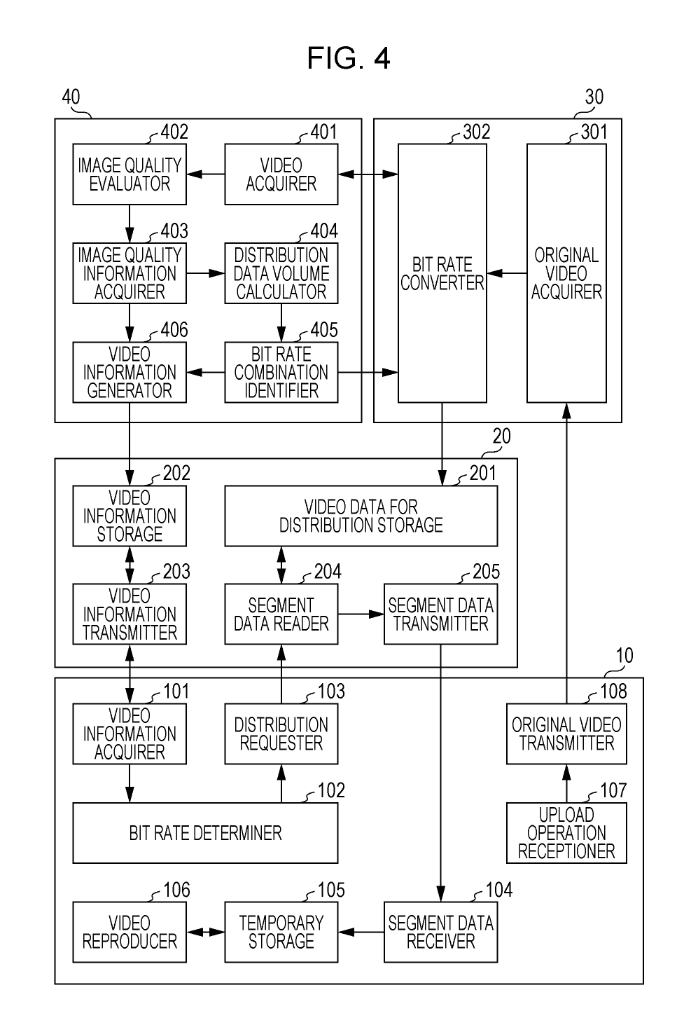

The functions described below are achieved by controlling each component through execution of a program by the CPU of each apparatus included by the video browsing system 1. FIG. 4 illustrates the functional configuration achieved by the video browsing system 1. The smartphone 10 includes a video information acquirer 101, a bit rate determiner 102, a distribution requester 103, a segment data receiver 104, a temporary storage 105, a video reproducer 106, an upload operation receptioner 107, and an original video transmitter 108.

The video distribution apparatus 20 includes a video data for distribution storage 201, a video information storage 202, a video information transmitter 203, a segment data reader 204, and a segment data transmitter 205. The video conversion apparatus 30 includes an original video acquirer 301 and a bit rate converter 302. The bit rate identification apparatus 40 includes a video acquirer 401, an image quality evaluator 402, an image quality information acquirer 403, a distribution data volume calculator 404, a bit rate combination identifier 405, and a video information generator 406.

The above-mentioned functions are broadly divided into the function related to video distribution and the function for preparing for streaming-distribution of a video (some include both functions). First, the function related to video distribution will be described. In the video browsing system 1, a video with a bit rate changeable during reproduction is streaming-distributed in compliance with the standard called Moving Picture Experts Group (MPEG)-Dynamic Adaptive Streaming over HTTP (DASH), for instance.

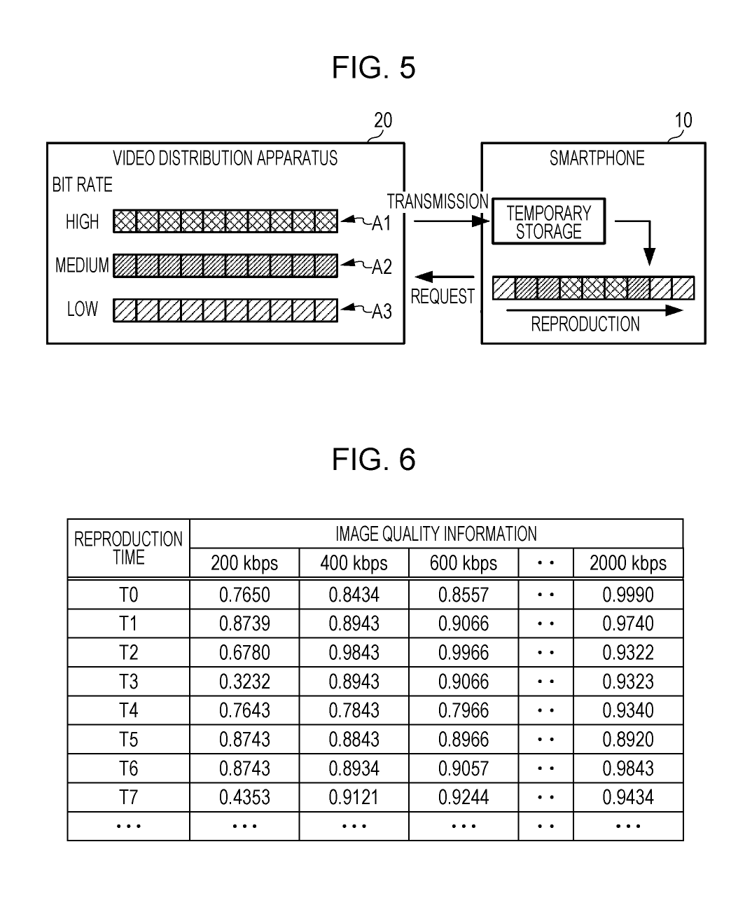

FIG. 5 illustrates the mechanism of streaming-distribution. In the example of FIG. 5, the video distribution apparatus 20 stores segment data groups A1, A2, A3 with respective bit rates “high”, “medium”, “low” as the video data for distribution. Each segment data is data that indicates a section of 1 to 10 seconds in a video, for instance. The length of the section is predetermined, for instance, in the video browsing system 1. As the bit rate of the video represented by each segment data group is increased, the video has a higher resolution and a higher frame rate.

When requesting streaming-distribution of a video, the smartphone 10 specifies a bit rate of the video to be distributed. The video distribution apparatus 20 sequentially reads segment data from a segment data group with the specified bit rate and transmits the segment data. The smartphone 10 temporarily stores (caches) the received segment data, and reads the cached segment data to reproduce the segment data.

Also, during reproduction of a video, when the smartphone 10 specifies a bit rate different from the bit rate of the video and requests distribution of the video, after receiving the request, the video distribution apparatus 20 transmits segment data with the new specified bit rate. Upon receiving the segment data, the smartphone 10 reproduces a video represented by the segment data with the new bit rate subsequent to a video represented by segment data with the previous bit rate.

Returning to FIG. 4, a description is given. As described above, the video data for distribution storage 201 of the video distribution apparatus 20 stores the video data for distribution (the video data used for streaming-distribution, that is, the segment data groups A1, A2, A3 in the example of FIG. 5) generated by the video conversion apparatus 30.

The video information storage 202 stores video information on the video represented by the video data for distribution stored in the video data for distribution storage 201. The video information includes bit rate information on the videos indicated by the video data for distribution, and image quality information indicating the image quality in each of multiple sections of those videos. The video information storage 202 stores, for instance, Media Presentation Description (MPD) in MPEG-DASH as bit rate information.

In addition, as image quality information, the video information storage 202 stores an index expressed by the magnitude of change in each of the videos from the original video, indicated by the video data for distribution. The index is expressed by using, for instance, the mean square error (MSE) method, the peak signal to noise ratio (PSNR) method, or the structural similarity (SSIM) method. Each index indicates that an image having no difference from the original video has the highest quality, and the image quality reduces as the difference from the original image increases. That is, the image quality information is information that indicates a level of deterioration of an image from the original video. In this exemplary embodiment, the video information storage unit 202 stores SSIM (1 is an index indicating the highest image quality, and 0 an index indicating the lowest image quality) as image quality information.

FIG. 6 illustrates an example of stored image quality information. In the example of FIG. 6, for videos with 10 types of bit rate of “200 kbps”, “400 kbps”, “600 kbps”, “2000 bps” with an interval of 200 kbps, evaluated image quality information (SSIM) on a frame at each of reproduction times of “T0”, “T1”, “T2”, . . . is illustrated. These reproduction times are each defined as the time that represents each section in streaming-distribution. The video information including the bit rate information and the image quality information described above is generated by the later-described video information generator 406 of the bit rate identification apparatus 40 in this exemplary embodiment.

For instance, when a reproduction start operation (such as an operation of selecting a link to a video on a web page) of a video is performed by a user, the video information acquirer 101 of the smartphone 10 acquires video information on the video from the video distribution apparatus 20. Specifically, the video information acquirer 101 transmits request data for requesting video information on the video to the video distribution apparatus 20. The request data includes information that identifies a video (such as the Uniform Resource Locator (URL) to a MPD file in MPEG-DASH, for instance).

When the video information transmitter 203 of the video distribution apparatus 20 receives the request data transmitted from the smartphone 10, the video information transmitter 203 reads a video identified by the request data, that is, video information on the video stored in the video distribution apparatus 20 from the video information storage 202, and transmits the video information to the smartphone 10 which is a request source. The video information acquirer 101 acquires thus transmitted video information, and supplies the acquired video information to the bit rate determiner 102.

The bit rate determiner 102 determines that one of the multiple bit rates indicated by the video information acquired by the video information acquirer 101 be the bit rate of a video reproduced. In this exemplary embodiment, the bit rate determiner 102 determines that the least one of bit rates of the video for which a level of degradation from the original video in each section of the video satisfies an image quality condition be the bit rate of the video reproduced. The image quality condition used here, that is, the image quality condition used to determine the bit rate of the video reproduced is an example of the “first image quality condition” of the present invention.

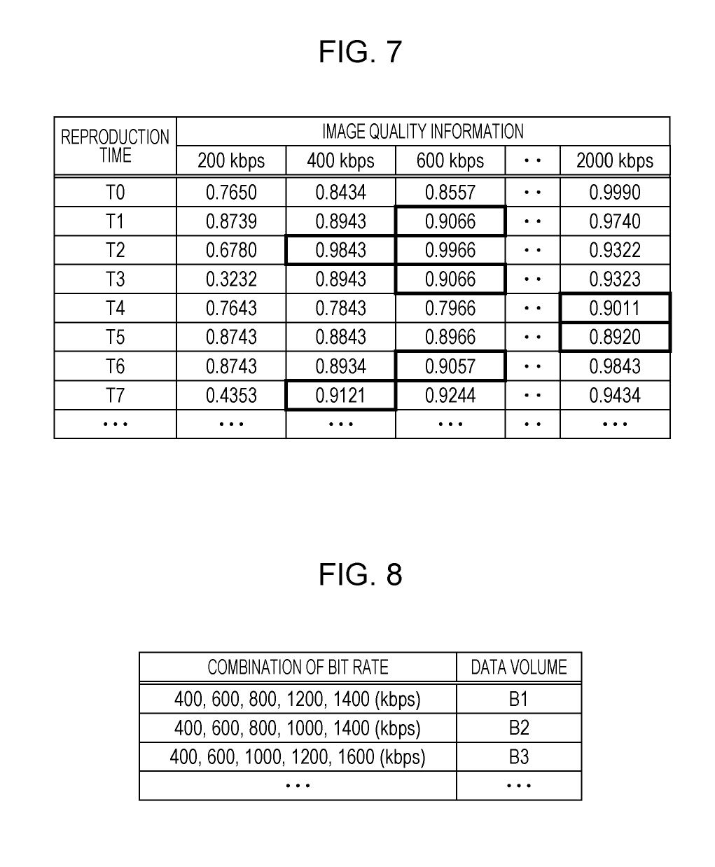

FIG. 7 illustrates an example of determined bit rates. In the example of FIG. 7, out of the bit rates illustrated in FIG. 6, a bit rate determined in a section including one of the reproduction times is indicated. In this example, it is assumed that when the image quality information indicates 0.9 or higher, the image quality condition is satisfied. For instance, in the interval including the reproduction time “T1”, “600 kbps” with the image quality information of “0.9066” is determined, and in the interval including “T2”, “400 kbps” with the image quality information of “0.9843” is determined.

It is to be noted that in the interval including the reproduction time “T0”, a bit rate omitted in FIG. 7 is assumed to be determined. Also, in the interval including the reproduction time “T5”, “2000 kbps” with the image quality information indicating a maximum is determined because there is no bit rate with the image quality information indicating 0.9 or higher. The bit rate determiner 102 repeatedly determines a bit rate at a predetermined time interval. As the time interval, for instance, an interval of time (for instance, when the section is two second long, every one second) shorter than the section of a video indicated by one piece of segment data is used. Every time when determining a bit rate, the bit rate determiner 102 notifies the distribution requester 103 of the determined bit rate.

The distribution requester 103 specifies the bit rate determined by the bit rate determiner 102, and requests streaming-distribution of a video from the video distribution apparatus 20. When the bit rate determined by the bit rate determiner 102 changes, the bit rate specified by the distribution requester 103 also changes accordingly.

When streaming-distribution of a video is requested from an external apparatus, the segment data reader 204 of the video distribution apparatus 20 reads segment data of the video with the bit rate specified in the request. Specifically, when receiving the request for the first time, the segment data reader 204 sequentially reads a predetermined number of segment data from the segment data groups with the specified bit rate from the start of the video.

Subsequently, the segment data reader 204 repeatedly performs processing of reading a predetermined number of segment data from the data following the segment data already read at an interval of the reproduction time of a portion of the video indicated by segment data read at one time, or at an interval of time shorter than the reproduction time. When the specified bit rate is changed during the reading, the segment data reader 204 reads a predetermined number of segment data from part of data to be reproduced out of segment data with a new bit rate. Every time reading segment data, the segment data reader 204 supplies the read segment data to the segment data transmitter 205.

The segment data transmitter 205 transmits the supplied segment data to a request source (the smartphone 10 in this exemplary embodiment) which has requested streaming-distribution of a video. The segment data receiver 104 of the smartphone 10 receives the segment data transmitted from the video distribution apparatus 20, and supplies the received segment data to the temporary storage 105.

The temporary storage 105 temporarily stores the segment data received by the segment data receiver 104 until the portion of the video indicated by the segment data is reproduced. When the segment data is stored in the temporary storage 105, the video reproducer 106 reads the stored segment data sequentially, and sequentially reproduces the video indicated by the read segment data. The function related to video distribution has been described so far.

Next, the function for preparing for a video to be distributed will be described. Hereinafter the case where a user who utilizes the smartphone 10 uploads an original video will be described. The upload operation receptioner 107 of the smartphone 10 receives an original video upload operation by a user. The upload operation includes, for instance, selection of a video stored in the smartphone 10 and an operation (such as login to the site and input of supplementary information (such as a video name, descriptive sentences of the video and a keyword for retrieval)) along the steps of uploading the video to a video distribution site, that is, an operation of specifying an original video.

The upload operation receptioner 107 notifies the original video transmitter 108 of a storage location and a transmission destination (the video conversion apparatus 30 in this exemplary embodiment) of a video uploaded by the received operation. The original video transmitter 108 reads the video uploaded by the operation received by the upload operation receptioner 107, and transmits the video to the video conversion apparatus 30 as the original video. In this process, the original video transmitter 108 transmits the supplementary information on the original video along with the video.

The original video acquirer 301 of the video conversion apparatus 30 acquires the original video which has been specified as the video to be streaming-distributed. The original video acquirer 301 acquires a video transmitted, for instance, from the smartphone 10 as the original video. The original video acquirer 301 also acquires the supplementary information on the original video, and transmits the acquired original video and supplementary information to a web server apparatus that provides a web page including a link to the original video. The web server apparatus provides a web page that includes a thumbnail image of and the supplementary information on the original video. On the web page, the above-described reproduction start operation of the video is performed.

The bit rate converter 302 converts the bit rate of the original video acquired by the original video acquirer 301 into at least one or more bit rates, and generates conversion videos each with a bit rate different from the bit rate of the original video. The bit rate converter 302 is an example of the “generator” of the present invention. In this exemplary embodiment, when the original video is supplied from the original video acquirer 301, the bit rate converter 302 converts the original video into videos with predetermined types of bit rate (for instance, 10 types of bit rate from 200 kbps to 2000 kbps illustrated in FIG. 6). After performing the conversion processing to generate 10 conversion videos, the bit rate converter 302 transmits those generated conversion videos and the original video to the bit rate identification apparatus 40.

The video acquirer 401 of the bit rate identification apparatus 40 acquires the conversion videos generated by the bit rate converter 302 and the original video. In this exemplary embodiment, the video acquirer 401 acquires the above-described 10 conversion videos and the original video, and supplies those acquired videos to the image quality evaluator 402.

The image quality evaluator 402 evaluates the image quality in multiple sections of the conversion videos acquired by the video acquirer 401. The multiple sections referred to here are sections into which a video is divided in streaming-distribution, and the image quality refers to the above-described level of degradation of an image from the original video. In this exemplary embodiment, the image quality evaluator 402 compares a frame at a reproduction time representing a corresponding one of the sections illustrated in FIG. 7 with a frame corresponding to the original video, and calculates the index (a value 0 or higher and 1 or lower indicated by SSIM in this exemplary embodiment) of the above-described level of degradation, thereby evaluating the image quality in a section including the reproduction time.

Each frame used here is a frame of a conversion video which is actually generated by the bit rate converter 302 using the original video. In other words, the image quality evaluator 402 calculates a level of degradation from the original video by comparing multiple videos actually generated from the original video with the original video. The image quality evaluator 402 is an example of the “calculator” of the present invention. It is to be noted that although a reproduction time represents each section in the example of FIG. 7, two reproduction times may represent each section and the image quality evaluator 402 may calculate an average value of the index values of level of degradation of a frame at the reproduction times to evaluate the image quality in each section.

In short, it is sufficient that an index be calculated so that the image quality of a video is evaluated in all sections. For instance, every time calculating an index of level of degradation in each section of each of the conversion videos, the image quality evaluator 402 supplies the value of the calculated index along with the bit rate of the conversion video used for the calculation and the reproduction time of the frame to the image quality information acquirer 403 as evaluation results.

The image quality information acquirer 403 acquires image quality information indicating the image quality in multiple sections of the conversion video, evaluated by the image quality evaluator 402. The image quality information is information that, when the original video is converted into multiple videos (multiple conversion videos) with different bit rates, indicates levels of degradation in multiple sections of each of the videos. The image quality information acquirer 403 is an example of the “degradation level acquirer” of the present invention. In this exemplary embodiment, as described above, the image quality information acquirer 403 acquires a level of degradation (a level of degradation evaluated by the image quality evaluator 402 based on the comparison) obtained by comparing multiple videos actually generated from the original video with the original video.

The image quality information acquirer 403 generates information that associates a bit rate and a reproduction time with an index value indicated by the evaluation results, for instance, as in the example illustrated in FIG. 7, based on the evaluation results supplied from the image quality evaluator 402, and acquires the information as image quality information. It is to be noted that the image quality evaluator 402 may generate the image quality information and the image quality information acquirer 403 may acquire the generated image quality information. The image quality information acquirer 403 supplies the acquired image quality information to the distribution data volume calculator 404 and the video information generator 406.

The distribution data volume calculator 404 uses the image quality information (information indicating a level of degradation of the video) acquired by the image quality information acquirer 403, and calculates the data volume of distribution video data generated when a video having a level of degradation satisfying the image quality condition is selected in each section from the multiple videos from which the image quality information is acquired. The distribution data volume calculator 404 is an example of the “data volume calculator” of the present invention.

The distribution video data referred to here is data that indicates the distribution video indicated by the segment data actually distributed out of the segment data of multiple videos included in the video data for distribution. Let A (A is a natural number) be the number of conversion videos for which image quality information is acquired, then the distribution data volume calculator 404 calculates the data volume of the distribution video data from B (B is a natural number) videos (all conversion videos in this exemplary embodiment) less than A.

The number B referred to here indicates the number of videos (the number of bit rates) that are stored as the video data for distribution by the video distribution apparatus 20. In this exemplary embodiment, the distribution data volume calculator 404 calculates a data volume for each of multiple combinations of selecting B bit rates from the bit rates of A videos. Like this, the number A indicates the number of videos included in the parent population from which B videos are extracted. The distribution data volume calculator 404 calculates the data volume when the number of conversion videos is 10 (A=10) as in the example of FIGS. 6 and 5 (B=5) conversion videos serve as the distribution video data.

In this case, the distribution data volume calculator 404 calculates a data volume for each of multiple combinations of selecting 5 conversion videos (bit rates) from 10 conversion videos (bit rates), that is, ₁₀C₅=(10×9×8×7×6)÷(5×4×3×2×1)=126 combinations. In this example, the distribution data volume calculator 404 calculates a data volume for each of all combinations of selecting B bit rates from the bit rates of A videos.

It is not necessary to calculate a data volume for each of all combinations. For instance, for a combination (such as a combination of selecting B largest bit rates) which obviously allows the data volume to increase, the distribution data volume calculator 404 may not calculate a data volume, so that the time taken for calculation of the data volumes may be reduced as compared with the case where a data volume is calculated for each of all combinations.

The data volume calculated by the distribution data volume calculator 404 indicates the data volume of the segment data transmitted by the video distribution apparatus 20, that is, the segment data received by the smartphone 10 when the video distribution apparatus 20 stores B conversion videos as the video data for distribution and performs streaming-distribution of the video. For instance, when the image quality information (the level of degradation from the original video) illustrated in FIG. 6 is acquired and a level of degradation of 0.9 or higher satisfies the image quality condition, as illustrated in FIG. 7, the distribution data volume calculator 404 selects a minimum bit rate in each section out of the bit rates of 0.9 or higher of the image quality information.

In this manner, the distribution data volume calculator 404 selects a bit rate by a method common with the method of determining a bit rate used by the bit rate determiner 102. The distribution data volume calculator 404 calculates the total of the data volume of segment data with thus selected bit rate as the data volume of the distribution video data. The distribution data volume calculator 404 supplies the calculated data volume to the bit rate combination identifier 405.

From the combinations of the bit rates of B videos, for which the data volume has been calculated by the distribution data volume calculator 404, the bit rate combination identifier 405 identifies the combinations, for each of which the calculated data volume is within a predetermined order from the smallest. The bit rate combination identifier 405 is an example of the “identifier” of the present invention. In this exemplary embodiment, the bit rate combination identifier 405 sets the determined order to the first order, in other words, identifies a combination that achieves a minimum of the calculated data volume.

FIG. 8 illustrates an example of the calculated data volume. In the example of FIG. 8, the data volume is “B1” for the combination of bit rates “400, 600, 800, 1200, 1400 (kbps)”, the data volume is “B2” for “400, 600, 800, 1000, 1400 (kbps)”, and the data volume is “B3” for “400, 600, 1000, 1200, 1600 (kbps)” (where B1<B2<B3). The data volume for each of other combinations is assumed to be greater than B3. In this case, the bit rate combination identifier 405 identifies the combination of bit rates “400, 600, 800, 1200, 1400 (kbps)” which achieve a minimum data volume of B1.

When the combinations for the data volumes B1 and B2 are compared, the bit rates “400, 600, 800, 1400 (kbps)” are in common, and the remaining bit rates “1200”, “1000” are different. Like this, a smaller data volume with a higher bit rate included in a combination occurs, for instance, in the case where there are many sections in which the image quality condition is not satisfied for the bit rate “1000” for instance, but the image quality condition is satisfied for the bit rate “1200”.

In this case, “1200” is selected for the combination of B1, whereas “1400” is selected for the combination of B2, and therefore the combination of B2 has a greater data volume than the combination of B1. The bit rate combination identifier 405 transmits bit rate information indicating thus identified combination of bit rates to the video conversion apparatus 30, and supplies the bit rate information to the video information generator 406.

When receiving the transmitted bit rate information, the bit rate converter 302 of the video conversion apparatus 30 transmits the conversion videos with the bit rates indicated by the received bit rate information out of the generated conversion videos to the video distribution apparatus 20 in this exemplary embodiment. The video data for distribution storage 201 of the video distribution apparatus 20 stores the transmitted conversion videos as the video data for distribution.

The video information generator 406 of the bit rate identification apparatus 40 generates information including the image quality information supplied from the image quality information acquirer 403 and the bit rate information supplied from the bit rate combination identifier 405, as the video information. The video information generator 406 transmits thus generated video information to the video distribution apparatus 20. The video information storage 202 of the video distribution apparatus 20 stores the transmitted video information. As described above, the video distribution apparatus 20 stores the video data for distribution and the video information, and thus preparation for distribution of the uploaded original video is completed. The function for preparing for a video to be distributed has been described so far.

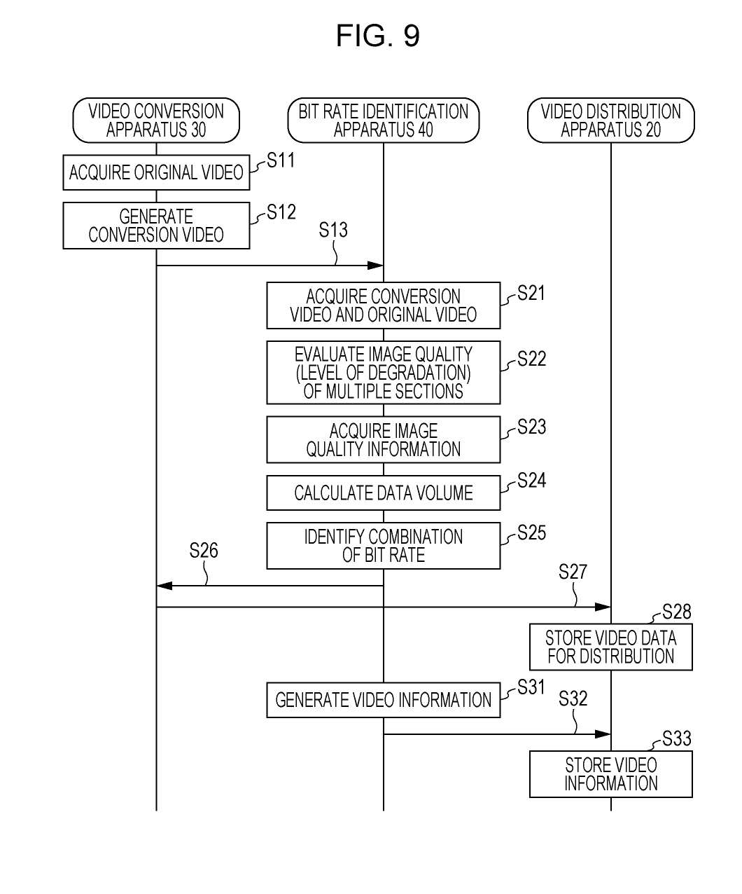

Each apparatus included in the video browsing system 1 performs distribution preparation processing of preparing for streaming-distribution of a video based on the above-described configuration. FIG. 9 illustrates an example of steps of operation of each apparatus in the distribution preparation processing. The steps of operation illustrated in FIG. 9 start, triggered by an operation by a user of uploading an original video via the smartphone 10, for instance.

First, the video conversion apparatus 30 (the original video acquirer 301) acquires an original video (step S11). Next, the video conversion apparatus 30 (the bit rate converter 302) generates conversion videos each with a different bit rate converted from the bit rate of the original video (step S12). The generated conversion videos and the acquired original video are transmitted to the bit rate identification apparatus 40 (step S13). The bit rate identification apparatus 40 (the video acquirer 401) acquires the transmitted conversion videos and the original video (step S21). Next, the bit rate identification apparatus 40 (the image quality evaluator 402) compares the acquired conversion videos with the original video and evaluates a level of degradation from the original video indicating the image quality in each of multiple sections of each conversion video (step S22).

Subsequently, the bit rate identification apparatus 40 (the image quality information acquirer 403) acquires image quality information in multiple sections of the conversion video evaluated in step S22 (step S23). Next, the bit rate identification apparatus 40 (the distribution data volume calculator 404) calculates the data volume of the distribution video data generated when a video having a level of degradation satisfying the image quality condition is selected in each section from the multiple videos from which the image quality information is acquired (step S24).

Subsequently, from the combinations of the bit rates of multiple videos, for which the data volume has been calculated in step S24, the bit rate identification apparatus 40 (the bit rate combination identifier 405) identifies the combinations, for each of which the calculated data volume is within a predetermined order from the smallest (step S25). The bit rate information indicating the identified combinations is transmitted to the video conversion apparatus 30 (step S26). The video conversion apparatus 30 (the bit rate converter 302) transmits the conversion videos with the bit rates indicated by the received bit rate information to the video distribution apparatus 20 (step S27). The video distribution apparatus 20 (the video data for distribution storage 201) stores the transmitted conversion videos as the video data for distribution (step S28).

Also, (the video information generator 406) of the bit rate identification apparatus 40 generate video information including the image quality information acquired in step S23 and the bit rate information indicating the bit rates in the combinations identified in step S25 (step S31), and the generated video information is transmitted to the video distribution apparatus 20 (step S32). The video distribution apparatus 20 (the video information storage 202) stores the transmitted video information (step S33). Thus, preparation for streaming-distribution of a video is completed.

As described above, in the video distribution apparatus 20 that performs streaming-distribution of a video using a dynamically selected bit rate, the greater the number of videos stored as the video data for distribution, the better. However, the number is limited due to a condition on a storage capacity or the like. Then, a combination of a limited number of bit rates is selected, and the videos with the selected bit rates are stored as the video data for distribution. In this case, videos with the bit rates of the same combination are stored all the times as the video data for distribution, for instance.

Then, only a bit rate for high quality is selected depending on the content of a video, and the data volume of the distribution video data is increased and reproduction is likely to be cut off, and thus quality of reproduction may be reduced. In this exemplary embodiment, as described above, the data volume of the distribution video data is calculated in advance, which is generated when a video having a level of degradation satisfying the image quality condition is selected in each section, and a combination of bit rates which achieve a minimum data volume is identified. Consequently, as the combination of bit rates of a video distributed using bit rates dynamically selected by the video distribution apparatus 20, a combination for higher quality of reproduction can be found, as compared with the case where the same combination is selected all the times.

[2] Modifications

The exemplary embodiment described above is only an example of implementation of the present invention, and may be modified as follows. Alternatively, the exemplary embodiment and each modification may be combined and carried out as necessary.

[2-1] Method of Identifying Combination

The bit rate combination identifier 405 may identify a combination of bit rates by a different method from the method of the exemplary embodiment. For instance, in the exemplary embodiment, any bit rate may not be included in a combination depending on the original video. However, in this modification, bit rates which are included without fail in a combination are defined.

In this modification, the bit rate combination identifier 405 identifies a combination including a predetermined C (C is a natural number) bit rates. Each of predetermined bit rates which are fixed like this is referred to as a “constant bit rate”. The number C is assumed to be smaller than the above-described number B which is the number of videos (the number of bit rates) stored as the video data for distribution by the video distribution apparatus 20. When the video data for distribution are those five videos described in the exemplary embodiment, for instance, two bit rates are predefined as the constant bit rates.

As the constant bit rate, a bit rate is defined, which allows any video to be desirably transmitted to, for instance, an expected reproduction device. As an example, for a small-sized smartphone which has a small display screen and may have an adverse communication environment, 200 kbps is defined as the constant bit rate, and thus even in an adverse communication environment, streaming-distribution in which reproduction is not likely to be cut off is performed.

Also, for a desktop PC which has a big screen and allows large capacity data communication by a wired communication, 2000 kbps is defined as the constant bit rate, and thus for any video, streaming-distribution with the highest image quality is performed. In this modification, the distribution data volume calculator 404 calculates a data volume for each of multiple combinations of selecting B bit rates including C constant bit rates from the bit rates of A videos.

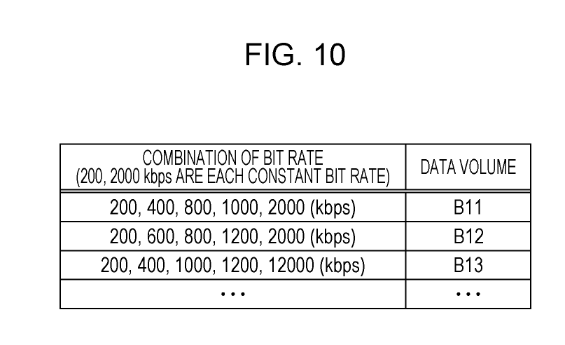

FIG. 10 illustrates an example of data volume calculated in this modification. In the example of FIG. 10, 200, 2000 kbps are defined as the constant bit rates, and the data volume for the combination of bit rates “200, 400, 800, 1000, 2000 (kbps)” is calculated as “B11”. Similarly, the data volume “B12” for “200, 600, 800, 1200, 2000 (kbps)”, and “B13” for “200, 400, 1000, 1200, 2000 (kbps)” are calculated (where B11<B12<B13). The data volume for each of other combinations is assumed to be greater than B13.

In this case, the bit rate combination identifier 405 identifies the combination of bit rates “200, 400, 800, 1000, 2000 (kbps)” which achieve a minimum data volume of B11. According to this modification, as described above, a video with a bit rate, which allows any video to be desirably transmitted to an expected reproduction device, is stored as the video data for conversion in the video distribution apparatus 20. Consequently, a video with a constant bit rate is included without fail in the video distributed.

[2-2] Calculation Method 1 for Data Volume

In the exemplary embodiment, a data volume is calculated for a combination including only the bit rate (referred to as an “actually generated bit rate”) of an actually generated conversion video. However, in this modification, when it is assumed that a conversion video which is not actually generated is generated, image quality information in the bit rate of the conversion video, that is, a level of degradation from the original video is estimated, and a data volume is calculated for a combination (a combination of the actually generated bit rate(s)+the estimated bit rate(s), a combination of only the estimated bit rates) including also the bit rate (referred to as an “estimated bit rate”) for which the level of degradation is estimated.

In this modification, the case where the actually generated bit rate is a constant bit rate will be described. The bit rate combination identifier 405 of this modification identifies a combination including a predetermined D (D is a natural number) constant bit rates. The number D is assumed to be smaller than the above-described number B which is the number of videos (the number of bit rates) stored as the video data for distribution by the video distribution apparatus 20, and to be greater than or equal to two in this modification. When the video data for distribution are those five videos described in the exemplary embodiment, for instance, two bit rates are predefined as the constant bit rates.

In this modification, when the original video is supplied from the original video acquirer 301, the bit rate converter 302 generates conversion videos with the above-described D types of bit rate converted from the original video. The image quality evaluator 402 compares the generated conversion videos with D actually generated bit rates with the original video, and evaluates a level of degradation of each of the D conversion videos. The image quality evaluator 402 calculates an approximate expression which indicates the relationship between thus evaluated level of degradation of the actually generated bit rate and the actually generated bit rate, using a well-known approximation technique such as the least square method, and a level of degradation determined by substituting an estimated bit rate into the calculated approximate expression is evaluated as the level of degradation of the substituted estimated bit rate.

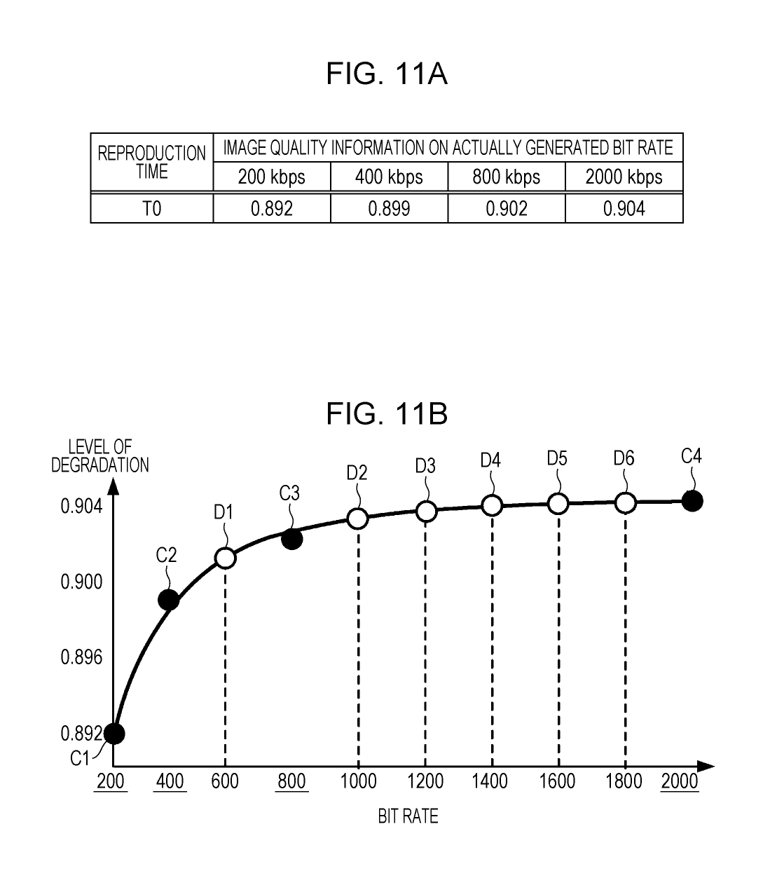

FIGS. 11A and 11B illustrate an example of level of degradation evaluated by the approximate expression. In FIG. 11A, as the image quality information (the level of degradation) on actually generated bit rates at reproduction time T0, the relationship of 200 kbps=0.892, 400 kbps=0.899, 800 kbps=0.902, and 2000 kbps=0.904 is illustrated. In FIG. 11B, in the graph where the vertical axis represents the level of degradation and the horizontal axis represents the bit rate, an approximate curve F1 is illustrated, which indicates the approximate expression calculated by the image quality evaluator 402 from the relationship. In this graph, the relationship between the actually generated bit rates (200, 400, 800, 2000 which are underlined) and the levels of degradation (0.892, 0.899, 0.902, 0.904) is illustrated by black dots C1, C2, C3, C4.

The image quality evaluator 402 substitutes the estimated bit rates 600, 1000, 1200, 1400, 1600, 1800 (kbps) into the approximated curve F1, thereby determining corresponding levels of degradation. In FIG. 11B, white dots D1, D2, D3, D4, D5, D6 indicating the relationship between those estimated bit rates and the determined levels of degradation are illustrated on the approximated curve F1.

The image quality information acquirer 403 acquires the levels of degradation of the actually generated bit rates and the levels of degradation of the estimated bit rates thus evaluated by the image quality evaluator 402, that is, the levels of degradation of A videos (the videos each with an actually generated bit rate and the videos each with an estimated bit rate, which are 10 videos in the example of FIG. 11) indicated by the levels of degradation from the original video, obtained by comparing the original video with the videos generated by converting the bit rate of the original video into D actually generated bit rates.

The distribution data volume calculator 404 calculates a data volume for each of multiple combinations of selecting B bit rates including D actually generated bit rates from the bit rates of A videos. As a specific example, the distribution data volume calculator 404 calculates a data volume for each of multiple combinations such as (200, 400, 600, 800, 2000, 200, 400, 800, 1000, 2000) of selecting five bit rates including four actually generated bit rates (200, 400, 800, 2000) illustrated in FIG. 11A from the bit rates of 10 videos illustrated in FIG. 11B.

The bit rate combination identifier 405 identifies a combination of bit rates, which achieves a minimum of thus calculated data volume. Since each conversion video with an actually generated bit rate has been already generated out of thus identified combinations of bit rates, the bit rate converter 302 of the video conversion apparatus 30 generates a conversion video with an estimated bit rate included in the combination from the original video. Consequently, the video data for distribution storage 201 of the video distribution apparatus 20 stores the conversion videos each with an actually generated bit rate and the conversion videos each with an estimated bit rate as the video data for distribution.

According to this modification, as in the modification described above, a video with a constant bit rate, which allows any video to be desirably transmitted to an expected reproduction device, is stored as the video data for conversion in the video distribution apparatus 20. Since a conversion video is not generated for an estimated bit rate, the time taken until a combination of bit rates is identified is reduced, as compared with the case where the conversion videos with all bit rates are generated, and thus the time taken from specification of an original video until streaming-distribution becomes available is reduced.

In contrast, when the conversion videos with all bit rates are generated as in the exemplary embodiment, the image quality (the level of degradation) is evaluated by comparing an actual conversion video with the original video, and thus a level of degradation is acquired with higher accuracy, as compared with the case where evaluation is made using an approximate expression, that is, where a level of degradation is acquired for a conversion video which is not generated. Like this, since accuracy of image quality evaluation and processing time have a trade-off relationship therebetween, the number of actually generated bit rates may be determined according to the service level (how long time should be set until streaming-distribution becomes available) demanded in streaming-distribution of a video.

[2-3] Calculation Method 2 for Data Volume

In the modification, each conversion video with an actually generated bit rate is a conversion video with a constant bit rate, and thus is stored as distribution video data without fail in the video distribution apparatus 20. However, this may not be always the case. In other words, a conversion video with an actually generated bit rate may be used only for calculating a level of degradation of a conversion video with an estimated bit rate. It is to be noted that as a result, a conversion video with an actually generated bit rate may be naturally included in the video data for distribution.

In this modification, the image quality evaluator 402 compares the generated conversion videos with E (E is a natural number) actually generated bit rates with the original video, and evaluates a level of degradation of each of the E conversion videos. The number of E is smaller than A which is the number of videos included in the parent population from which the above-described number B (the number of videos stored as the video data for distribution) videos are extracted, and the number of E is greater than or equal to two in this modification. As described with reference to FIG. 11, the image quality evaluator 402 calculates an approximate expression using a result of the evaluation, and evaluates a level of degradation of the estimated bit rate using the calculated approximate expression.

The image quality information acquirer 403 acquires the levels of degradation of the actually generated bit rates and the levels of degradation of the estimated bit rates thus evaluated by the image quality evaluator 402, that is, the levels of degradation of A videos indicated by the levels of degradation from the original video, obtained by comparing the original video with the videos generated by converting the bit rate of the original video into E actually generated bit rates. The A videos include, for instance, all of E conversion videos with an actually generated bit rate. In this case, the number of estimated bit rates is (A-E).

However, without being limited to this, the A videos may not include part or all of E conversion videos with an actually generated bit rate. This is because even in this case, the levels of degradation of A videos are acquired. The distribution data volume calculator 404 calculates a data volume for each of multiple combinations of selecting B bit rates from the bit rates of A videos, for each of which a level of degradation has been thus acquired. The B bit rates may or may not include an actually generated bit rate.

Also in this modification, as in the above-described modification, since a conversion video is not generated for an estimated bit rate, the time taken until a combination of bit rates is identified is reduced, as compared with the case where the conversion videos with all bit rates are generated, and thus the time taken from specification of an original video until streaming-distribution becomes available is reduced.

[2-4] Exclusion of Bit Rate

The bit rate combination identifier 405 may identify a combination of bit rates by a different method from the method of the exemplary embodiment or modifications. In this modification, when the original video is converted into F (F is a natural number) videos with different bit rates, the image quality information acquirer 403 acquires levels of degradation in multiple sections of each video. The number of F indicates a maximum of the number of videos (the number of bit rates) stored as the video data for distribution by the video distribution apparatus 20.

The image quality information acquirer 403 supplies image quality information indicating each acquired level of degradation and a corresponding bit rate to the bit rate combination identifier 405. The bit rate combination identifier 405 identifies a combination of bit rates of videos, for which multiple levels of degradation acquired from F videos overall satisfy the image quality condition. For instance, when the section, in which the acquired level of degradation is threshold value Th1 or higher, accounts threshold value Th2 or higher of the total section, the bit rate combination identifier 405 determines that the image quality condition is satisfied. The image quality condition used here, that is, the image quality condition used to determine whether or not a bit rate is excluded from a combination of bit rates is an example of the “second image quality condition” of the present invention.

For instance, it is assumed that F=5 and the levels of degradation of five videos with 200, 400, 800, 1200, 2000 (kbps) are acquired, and threshold value Th1 is 0.7 and threshold value Th2 is 70%. In this case, for instance, when the section, in which the level of degradation is 0.7 or higher, accounts 50% of the total section of a video with 200 kbps, the bit rate combination identifier 405 determines that the video does not satisfy the image quality condition (low image quality video), and excludes the bit rate of the video from the bit rates to be included in a combination.

In contrast, when the section, in which the level of degradation is 0.7 or higher, accounts 70% or higher of the total section of each of the videos with 400, 800, 1200, 2000 kbps, the bit rate combination identifier 405 determines that these four videos satisfy the image quality condition (high image quality video), and identifies the combination of these four bit rates.

In this manner, a low image quality video (a video that does not satisfy the image quality condition) is excluded from the video data for distribution, and thus the data volume of the video data for distribution (videos with the bit rates in an identified combination) stored by the video distribution apparatus 20 is reduced, as compared with the case where a low image quality video is included in the video data for distribution (more free space is saved in a storage area). On the other hand, since a low image quality video is less likely to be distributed than a high image quality video, the possibility of lowering the quality of reproduction of streaming-distribution is reduced, as compared with the case where a high image quality video is excluded.

[2-5] Addition of Alternative Bit Rate

When the bit rate of a low image quality video is excluded by the above-described method, the bit rate combination identifier 405 may add an alternative bit rate which serves as an alternative to the excluded bit rate. In this case, when F videos include a low image quality video that does not satisfy the image quality condition, the bit rate combination identifier 405 requests the video conversion apparatus 30 for an alternative video which is generated by converting the original video and has a different bit rate from the bit rate of the low image quality video.

For instance, when determining that the conversion video with 200 kbps is a low image quality video out of the conversion videos with 200, 400, 800, 1200, 2000 (kbps), the bit rate combination identifier 405 requests the video conversion apparatus 30 for an alternative video with a bit rate higher than 200 kbps by a predetermined value (for instance, 300 kbps which is higher than 200 kbps by 100 kbps). It is to be noted that when the bit rate is equal to the bit rate of a conversion video, the bit rate combination identifier 405 may request for an alternative video with a bit rate still higher than the bit rate by a predetermined value.

The bit rate converter 302 of the video conversion apparatus 30 generates an alternative video with the requested bit rate. The video acquirer 401 acquires the generated alternative video, and the image quality evaluator 402 evaluates the image quality (the level of degradation) of the acquired alternative video. The image quality information acquirer 403 acquires thus evaluated image quality of the alternative video, that is, multiple levels of degradation (levels of degradation in multiple sections) obtained by comparing the original video with the alternative video which is generated by converting the original video and has a different bit rate from the bit rate of the low image quality video.

When the multiple levels of degradation acquired by the image quality information acquirer 403 overall satisfy the image quality condition, the bit rate combination identifier 405 identifies a combination including the bit rate of the alternative video. For instance, as described above, when the section, in which the level of degradation is 0.7 or higher, accounts 70% or higher of the total section of the acquired alternative video with 300 kbps, the bit rate combination identifier 405 identifies the combination (300, 400, 800, 1200, 2000) of bit rates including 300 kbps which is the bit rate of the alternative video.

For instance, when many sections in a video satisfy the image quality condition (the first image quality condition described in the exemplary embodiment) in a range of a bit rate higher than 200 kbps and lower than 300 kbps, in the combination of (200, 400, 800, 1200, 2000), 400 kbps is selected for the sections. Even in the combination of (400, 800, 1200, 2000) in which the bit rate of the low image quality video is excluded, 400 kbps is selected for the sections.

In contrast, in the combination of (300, 400, 800, 1200, 2000) to which the bit rate of the alternative video is added, 300 kbps is selected for the sections. Therefore, when a combination to which the bit rate of the alternative video is added is identified, the data volume of the distribution video data is reduced, as compared with the case where a combination is identified without the addition or the exclusion of a bit rate.

[2-6] Distribution Including Original Video

In the exemplary embodiment and modifications, the original video is not included in the video data for distribution (the video data used for streaming-distribution) stored by the video distribution apparatus 20 does not. However, the original video may be included. In this case, the image quality evaluator 402 evaluates the image quality of the original video as the lowest level of degradation (SSIM value is 1), in other words, as the highest image quality.

Let A be the number of conversion videos for which the image quality information is acquired, the distribution data volume calculator 404 calculates the data volume of the distribution video data from B videos which is less than (A +1) in which the number of the original video is added to A. For instance, in the exemplary embodiment, the distribution data volume calculator 404 calculates a data volume for each of multiple combinations of selecting B bit rates from the bit rates ((A+1) bit rates) of A videos and the original video.

When a constant bit rate described in FIG. 10 is used, the distribution data volume calculator 404 calculates a data volume for each of multiple combinations of selecting B bit rates including C constant bit rates from the bit rates ((A+1) bit rates) of A videos and the original video.

Also, when the above-described exclusion and addition of a bit rate is performed, out of F videos, the bit rate combination identifier 405 identifies a combination of bit rates of the videos and the original video (since the degradation index of the original video is 1, the image quality condition is overall satisfied without fail), for which the acquired multiple levels of degradation overall satisfy the image quality condition. According to this modification, the segment data of the original video is also streaming-distributed.

[2-7] Reproduction Device

The reproduction device for a streaming-distributed video is not limited to a smartphone. For instance, a tablet terminal, a notebook computer, or a desktop personal computer may be used as a reproduction device. Any reproduction device may be used as long as the device reproduces a streaming-distributed video.

[2-8] Bit Rate

In the exemplary embodiment, as the bit rate is increased, the video has a higher resolution and a higher frame rate. However, without being limited to this, for instance, with an increased bit rate, the resolution may not be changed and only the frame rate may be increased, or the frame rate may not be changed and only the resolution may be increased.

[2-9] Method of Determining Bit Rate

The method of determining a bit rate is not limited to what has been described above. In addition to the above-described level of degradation, the bit rate determiner 102 may determine a bit rate using one or more of parameters: the size of the display area of a reproduction device, the amount of cache (the size of a temporary storage area) of a reproduction device, and the transmission speed of a reproduction device, for instance.

Specifically, the bit rate determiner 102 determines a higher bit rate for a larger size of the display area, a larger amount of cache, and a higher transmission speed. These parameters are determined when a reproduction device actually reproduces a video, and thus the parameters are not determined when the distribution data volume calculator 404 calculates a data volume. Thus, the distribution data volume calculator 404 identifies a parameter which is likely to be used in the near future, for instance, based on the types of the parameters used by the bit rate determiner 102 to determine a bit rate in the past streaming-distribution, and calculates a data volume using the image quality condition indicated by the identified parameter.

For instance, when the size of the display area is 640×480, the image quality condition with image quality information indicating a threshold value of 0.8 or higher is used, and when the size of the display area is 1280×720, the image quality condition with image quality information indicating a threshold value of 0.9 or higher is used. In this case, for instance, when the most frequently used size of the display area in the past is 640×480, the distribution data volume calculator 404 calculates a data volume using the image quality condition indicated by the size, that is, the image quality condition with image quality information indicating a threshold value of 0.8 or higher.

Also, when the ratio of use of 640×480 and 1280×720 is 2:1, the distribution data volume calculator 404 may calculate a data volume using the image quality condition with image quality information indicating a threshold value (0.8×2+0.9×1)+3=0.83) or higher, which is determined by assigning weights according to the ratio of use. According to this modification, even when the bit rate of a video to be streaming-distributed is determined using the parameters which are determined when a reproduction device actually reproduces the video, a data volume is calculated by the distribution data volume calculator 404.

[2-10] Apparatuses that Achieve Functions

Apparatuses that achieve the functions illustrated in FIG. 4 are not limited to the apparatuses illustrated in FIG. 4. For instance, the functions achieved by the video conversion apparatus 30 and the bit rate identification apparatus 40 may be achieved by one information processing apparatus. Also, the information processing apparatus may further achieve the function provided by the video distribution apparatus 20. Also, the function achieved by each apparatus may be achieved by two or more information processing apparatuses. For instance, the function of uploading an original video, provided by the smartphone 10 may be achieved by another information processing apparatus (a user terminal such as a personal computer utilized by a user or a work terminal utilized by a business operator).

Also, out of the functions achieved by the bit rate identification apparatus 40, for instance, the video acquirer 401, the image quality evaluator 402, and the video information generator 406 may be achieved by a first information processing apparatus, and the image quality information acquirer 403, the distribution data volume calculator 404, and the bit rate combination identifier 405 may be achieved by a second information processing apparatus. In this case, the second information processing apparatus is an example of the “information processing apparatus” of the present invention. In short, each function illustrated in FIG. 4 may be achieved by one of the multiple information processing apparatuses included in the video browsing system 1.

[2-11] Category of Invention

The present invention is applicable not only to an information processing apparatus such as a smartphone, a video distribution apparatus, a video conversion apparatus, and a bit rate identification apparatus, but also to an information processing system including those apparatuses. Also, the present invention is applicable to an information processing method for achieving the processing carried out by each apparatus, or applicable to a program for functioning a computer that controls each apparatus. The program may be provided in the form of recording medium such as an optical disc which stores the program, or may be provided in the form in which the program is downloaded to a computer via a communication line such as the Internet and installed to be available.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a degradation level acquirer that, when an original video is converted to A (A is a natural number) videos with different bit rates, acquires a level of degradation in each of a plurality of sections of each of the videos;
a data volume calculator that calculates a data volume of distribution video data which is generated when a video with the level of degradation satisfying a first image quality condition is selected from B (B is a natural number smaller than A+1) videos for each of the plurality of sections; and
an identifier that identifies a combination out of combinations of bit rates of the B videos for which the data volume is calculated, the combination allowing the data volume to be within a predetermined order from a smallest volume.

2. The information processing apparatus according to claim 1,
wherein the degradation level acquirer acquires the level of degradation obtained by comparing each of the A videos generated from the original video with the original video, and
the data volume calculator calculates the data volume for each of a plurality of combinations of selecting the B bit rates from the bit rates of the A videos or the bit rates of the A videos and the original video.

3. The information processing apparatus according to claim 1,
wherein the identifier identifies a combination including a predetermined C (C is a natural number smaller than the B) bit rates, and
the data volume calculator calculates the data volume for each of a plurality of combinations of selecting the B bit rates including the C bit rates from the bit rates of the A videos or the bit rates of the A videos and the original video.

4. The information processing apparatus according to claim 1,
wherein the identifier identifies a combination including a predetermined D (D is a natural number smaller than the B) bit rates,
the degradation level acquirer acquires the level of degradation of each of the A videos, indicated by the level of degradation obtained by comparing the original video with videos generated by converting a bit rate of the original video into the D bit rates, and
the data volume calculator calculates the data volume for each of a plurality of combinations of selecting the B bit rates including the D bit rates from the bit rates of the A videos or the bit rates of the A videos and the original video.

5. The information processing apparatus according to claim 1,
wherein the degradation level acquirer acquires the level of degradation of a bit rate of each of the A videos, indicated by the level of degradation obtained by comparing the original video with videos generated by converting a bit rate of the original video into E (E is a natural number smaller than the A) different bit rates.

6. An information processing apparatus comprising:
a degradation level acquirer that, when an original video is converted to F (F is a natural number) videos with different bit rates, acquires levels of degradation in a plurality of sections of each of the videos; and
an identifier that identifies a combination of bit rates of videos or a combination of bit rates of the videos and the original video out of the F videos, the videos allowing the acquired levels of degradation to overall satisfy a second image quality condition.

7. The information processing apparatus according to claim 6,
wherein when one of the F videos does not satisfy the second image quality condition, the degradation level acquirer acquires the level of degradation obtained by comparing the original video with an alternative video generated by converting the bit rate of the original video into a different bit rate from a bit rate of the one video, and
when the acquired levels of degradation for the alternative video overall satisfy the second image quality condition, the identifier identifies a combination including the bit rate of the alternative video.

8. An information processing system comprising:
the information processing apparatus according to claim 1;
a generator that generates a video in which the bit rate of the original video is converted; and
a calculator that calculates the level of degradation by comparing the generated video with the original video.
